(19) United States
(12) Patent Application Publication
(10) Pub. No.: US 2012/0179512 A1
(43) Pub. Date: Jul. 12, 2012

(54) CHANGE MANAGEMENT SYSTEM

(75) Inventor: Paul John O'Keeffe, Wauwatosa, WI (US)

(73) Assignee: Accenture Global Services Limited, Dublin (IE)

(21) Appl. No.: 13/345,037

(22) Filed: Jan. 6, 2012

Related U.S. Application Data
(60) Provisional application No. 61/430,829, filed on Jan. 7, 2011.

(51) Int. Cl. G06Q 10/06

(52) U.S. Cl. 705/7.37

(57) ABSTRACT

A change management system includes a data capture module to capture metrics associated with phases of a project and associated with a change management model. A prediction engine generates predictions indicating a level of readiness to move to a next phase of the project based on the model and also indicates actions for achieving goals of the project based on the predictions. A reporting module generates, via a user interface, predictions, actions and current change management state of the project.

### PRIORITY

The present application claims priority to U.S. provisional application Ser. No. 61/430,829, filed Jan. 7, 2011, which is incorporated by reference in its entirety.

### BACKGROUND

Companies, organizations and other entities frequently rollout new projects encompassing new or improved systems, businesses processes and other procedures to help improve their bottom line or achieve other goals. In many instances, implementation of these projects requires employees to perform different actions, which may be referred to as behavior changes. Whether the change is large or small, the ability to manage these behavior changes may be a critical component of achieving the goals of the project.

Furthermore, once these projects are implemented, it is often difficult to quantify the value, if any, that is being derived as a result of the project implementation. In addition, it is difficult to determine how certain behavior changes impacted the value and the ability to achieve the project goals.

### BRIEF DESCRIPTION OF DRAWINGS

The embodiments of the invention are described in detail in the following description with reference to the following figures.

FIG. 1 illustrates a change management system;

FIG. 2 illustrates a data flow for generating models;

FIG. 3 illustrates a data flow for generating predictions;

FIGS. 4A-D illustrate a four-quadrant model;

FIGS. 5 and 6 illustrate flow charts for generating predictions;

FIGS. 7-12 illustrate examples of screen shots that may be generated by the change management system; and

FIG. 13 illustrates a computer system that is operable to host the change management system, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

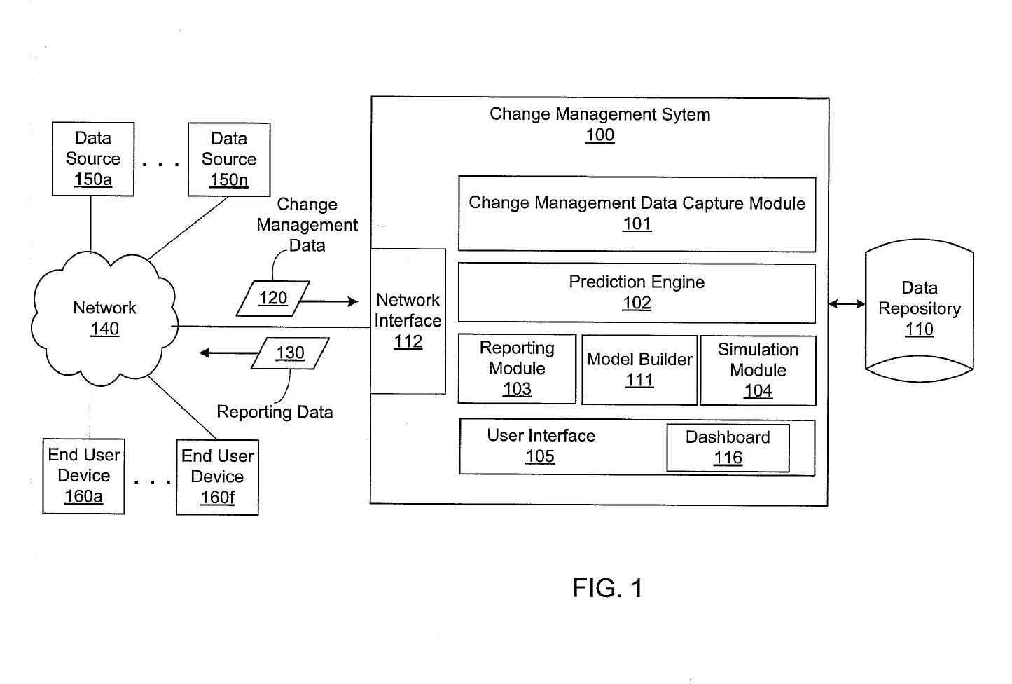

FIG. 1 illustrates a change management system 100, according to an embodiment. The change management system 100 may provide a comprehensive, data-driven approach to manage people change management decisions. The people change management decisions may be associated with any behavior changes to achieve certain results. The changes may be associated with a project. For example, if a project is to implement a new technology tool for manufacturing, certain user behaviors may need to change to implement and use the new technology. Examples of these user behaviors may include a different way of using the new tool when compared to the old tool and may include using the new tool for multiple different manufacturing processes. To implement the changes, users may need to be trained and a variety of other actions may need to be performed to implement the change. In another example, a new electronic medical record system is to be implemented in a hospital. User behaviors that may need to be changed for the new system to be successful may include new data entry procedures for physicians and other caregivers, using new devices for data entry, new accounting workflows, etc.

The change management system 100 may be used to guide change management decisions through predictive insights and actions throughout various phases of a project. The phases include pre-live and post-live phases of the project. The predictions may include predictions on how project goals and objectives are impacted given certain metrics and circumstances associated with behavior changes.

The change management system 100 is operable to determine predictions of readiness to move to a next phase of the project, which may include a project going live. A determination or prediction of readiness may include a determination of whether human behavior changes, which may be needed for project implementation, have been implemented or are ready to be implemented. Readiness may be measured through metrics that capture information describing training, skills, sponsorship and leadership characteristics, etc. These metrics may be used to estimate project success based on readiness and whether project goals will be achieved. If the entity is not ready for the change, then value, e.g., in terms of monetary costs and other goals, may not be achieved if the project is implemented. Project goals may be associated with reduction in time and costs or improvement in other metrics. The change management system 100 can be used for any type of project and provides overall knowledge about change management across many different projects. In addition to predicting project readiness, the change management system 100 is operable to identify areas to be improved to improve readiness.

Typically, organizations have no uniform way of measuring the impact of change. Thus, it is difficult for an organization to determine how they are performing relative to other companies who go through this type of change; how to make the link between change management and business benefits more tangible; and how behavior change requirements are truly impacting business results. The change management system 100 includes processes and systems for improving change management and quantifying the link between change management and business benefits.

As shown in FIG. 1, the change management system 100 includes change management data capture module 101, prediction engine 102, reporting module 103, simulation module 104, user interface 105, model builder 11 and network interface 112. The change management system 100 receives change management data 120, which includes any data associated with people change management decisions. This includes project data and other data described in detail below. Examples of metrics in the change management data 120 are also described below. The change management system 100 generates reporting data 130, which may include the predictive insights, actions and other information associated with guiding and managing the people change management decisions.

The data repository 110 stores the change management data 120, the reporting data 130, and any other data that may be used by the change management system 100. The data repository 110 may include a database or other data storage system. The data repository 110 may be include in the change management system 100 or a separate system.

The change management system 100 may be connected to a network 140 via the network interface 112. Data Sources 150a-n are shown connected to the network 140. The change management system 100 may receive the change management data 120 from the data sources 150a-n via the network 140. The data sources 150a-n may include systems capturing the change management data 120 electronically and providing it to the change management system 100. End user devices 160a-f are also shown. The end user devices 160a-f may connect to the change management system 100 via the network 140 to enter data and view reporting data 130. The data entered by the users via the end user devices 160a-f may include change management data 120. Although not shown, one or more of the data sources 150a-n and the end user devices 160a-f may be connected to the change management system 100 through a direct link, rather than a network. The change management system 100 may include I/O devices, such as a display, keyboard, mouse, etc., that allows users to enter and view data.

The user interface 105 may include a graphical user interface. For example, the user interface may be web-based. The user interface 105 may include a dashboard 106. The dashboard 106 presents the reporting data 130. The dashboard 106 may present the reporting data 130 in a manner that is easy to comprehend. Examples of screenshots that may be generated in the dashboard 106 are further described below.

The change management data capture module 101 captures the change management data 120 and stores the change management data 120 in the data repository 110. The change management data capture module 101 may receive and otherwise retrieve data from the data sources 150a-n. One of the sources may be a user entering at least some of the change management data 120. The change management data capture module 101 may generate screens via the user interface 105 for the user to enter the change management data 120.

The model builder 111 uses the change management data 120 to build models for estimating change readiness, which may be for a project. The prediction engine 102 may use the models to estimate change readiness. The model builder 111 may perform linear regression analysis on historic change management data to generate curves describing the relationship between change readiness and change management metrics. In one example, the model builder 111 may use conventional regression modeling to build the models for predictive analysis. The models may include linear regression models describing the relationship between a response or dependent variable and a set of independent or predictor variables. Ordinary least squares (OLS) estimation is a common function used to build linear regression models. Some of the metrics associated with the model may include project phase, industry type, location, function impacted by change, and other metrics described below with respect to a four-quadrant model. A four-quadrant model may be generated and stored in the data repository 110. The four quadrants in the model are change navigation, change leadership, change enablement, and change ownership. The model is described in further detail below. The model builder 111 may update models based on new historic change management data received at the system 100.

The prediction engine 102 generates predictive insights and actions associated with the project according to the models generated by the model builder 111. The predictive insights may include predictions on readiness, and whether change management goals will be achieved given the current change management circumstances. The predictive insights may include monetary values (describing business value) associated with change management behaviors that need to be implemented. The actions may include actions to be performed to achieve change management goals, which may be based on predictions that indicate an unsatisfactory level of readiness. Examples of actions in the reporting may include training, creating a steering committee, facilitating communication between leadership to formulate a unified vision of change and the benefits of the change, etc.

The reporting module 103 outputs the reporting data 130. This may include outputting the predictive insights, actions, and other information via the user interface 105.

The simulation module 104 simulates change management scenarios using the prediction engine 102. For example, the reporting module 103 may generate reports describing a current change management state of the project via the user interface 105, and the current state may include metrics describing the current state. The simulation module 104 allows a user to change values of the metrics to perform what-if analysis. The what-if analysis may be used to determine that if certain actions or behavior changes are performed causing one or more metrics to change, then the simulation module 104 generates an output indicating how the change impacts whether the project goals are achieved. The simulation module 104 may receive variations in the current state via the user interface and pass the variations to the prediction engine 102. The prediction engine 102 then generates the output indicating how the changes impact whether the project goals are achieved. The simulation module 104 may provide the output to the user via the user interface 105.

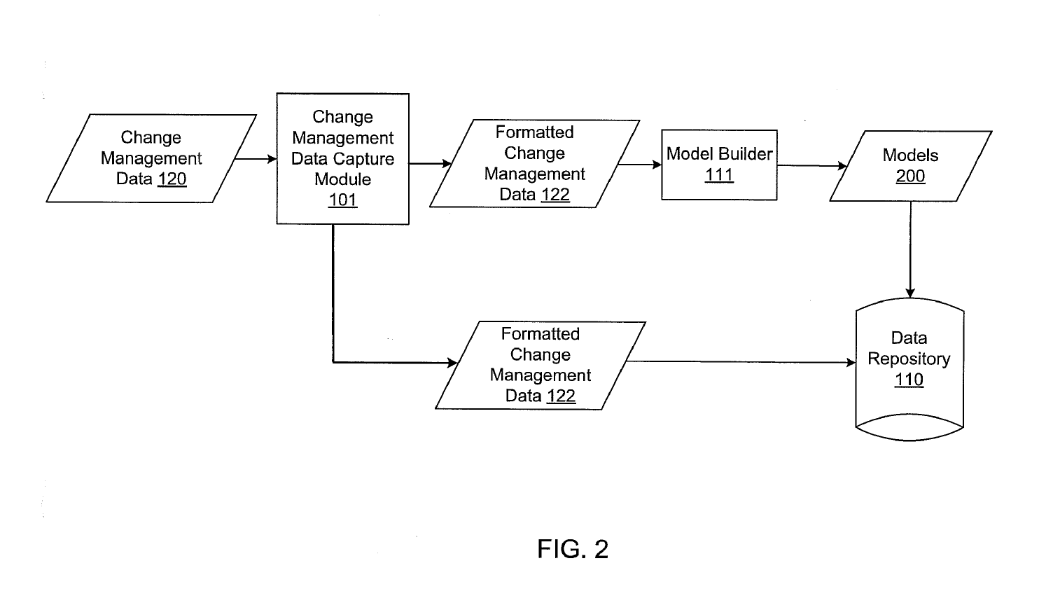

FIG. 2 illustrates a data flow diagram for generating models that may be used to make predictions for change management and perform other functions. For example, the change management data capture module 101 receives the change management data 120 from the data sources 150a-n. The change management data capture module 101 may retrieve the change management data 120 from the data sources 150a-n; may re-format the data into predetermined formats; may organize the data in a schema; and may store the data in the data repository 110. The change management data capture module 111 may provide the formatted change management data 122 to the model builder 111, or the model builder 111 may retrieve the change management data 120 from the data repository 110. The change management data capture module 101 captures the change management data 120 before and after the project goes live, and measures business value achieved through the project implementation.

The model builder 111 generates models 200 from the change management data 120. The models 200 may include predictive models for estimating change readiness for a project. As described above, in one example, the model builder 111 performs linear regression analysis on the change management data 120 to generate the models 200. The models 200 may represent the relationships between metrics for predicting change readiness and business metrics, such as return on investment.

The metrics in the models 200 may include factors that contributed to the successes and failures of achieving certain business value and other goals in the historic change management data. The models 200 correlate actions and behavior changes to business value and project goals. For example, an action may include attendance at training. A model may be used to predict the impact on achieving project goals based on percentage of attendance at training.

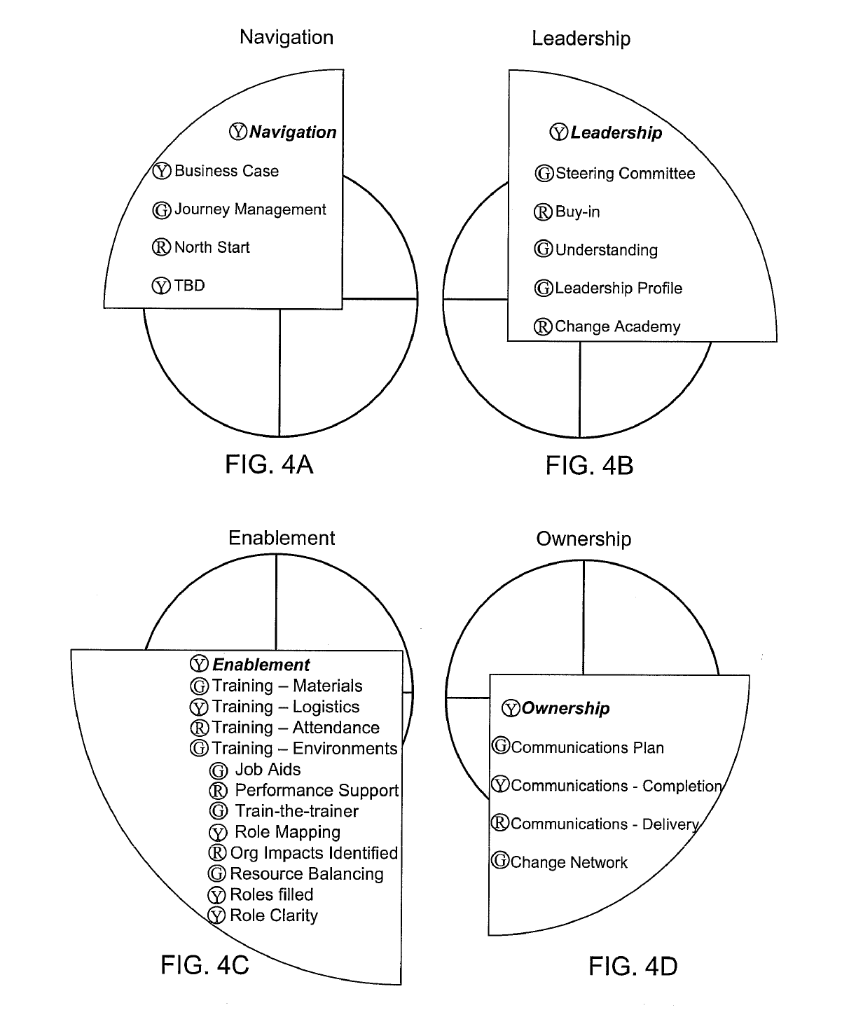

The models 200 may include the four-quadrant model. The four quadrants in the model are change navigation, change leadership, change enablement, and change ownership. The four-quadrant model is described with respect to FIGS. 4A-D. The models 200 may be stored in the data repository 110 as shown in FIG. 2.

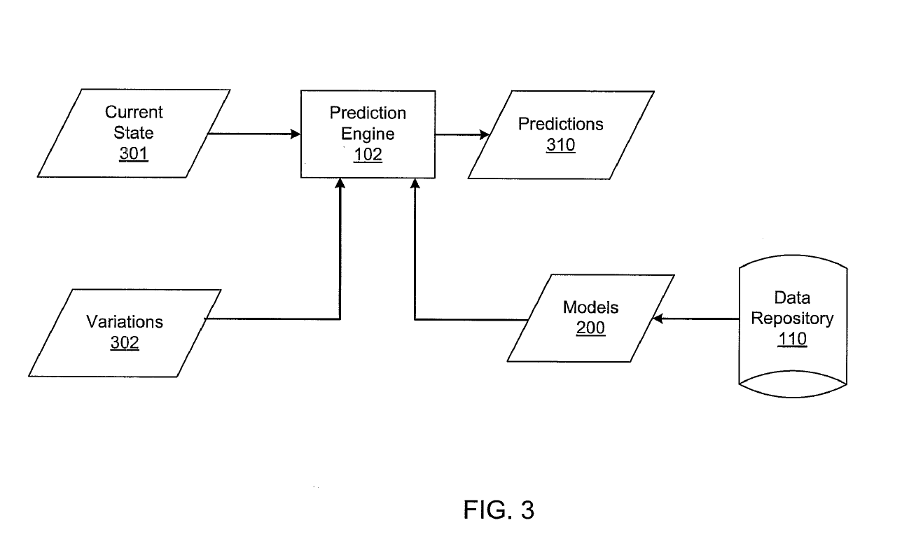

FIG. 3 illustrates a data flow diagram illustrating the prediction engine 102 making readiness predictions 310. FIG. 3 shows current state 301 which represents the current state of change management. The reporting module 103 may generate reports describing the current state of the project as it relates to change management via the user interface 105, and the current state 301 may include metrics describing the current state. The metrics for the current state 301 may be provided in the change management data 120 and stored in the data repository 110.

The prediction engine 102 receives the current state 301 and generates predictions 310 including predictive insights and actions, which may be associated with a project. The predictions 310 are generated using the models 200, which may be stored in the data repository 110. The predictions 310 may include predictions on readiness, and whether change management goals will be achieved given the current change management circumstances. The predictions 310 may include monetary values (describing business value) associated with change management behaviors that need to be implemented. The actions may include actions to be performed to achieve change management goals.

The simulation module 104 allows a user to change values of the metrics to perform what-if analysis to determine whether changes to certain to certain actions or behaviors can cause the predictions 310 to change. For example, if change readiness metrics indicate that a project should not go live, then changes are modeled to determine if they improve the metrics. The simulation module 104 may receive variations 302 to the current state, for example, via the user interface 105 and pass the variations 302 to the prediction engine 102. The prediction engine 102 then generates predictions indicating how the changes impact whether the project goals are achieved.

FIGS. 4A-D illustrate the four-quadrant model. The four quadrants in the model are change navigation, change leadership, change enablement, and change ownership, which are shown in FIGS. 4A-D respectively. The change management system 100 may capture metrics for each quadrant to determine project readiness. Examples of metrics are shown for each quadrant. Other metrics may be used.

The change navigation quadrant is shown in FIG. 4A and the metrics for this quadrant may be associated with management mechanisms that help optimize project investment and changes in behavior that need to be instilled in personnel for the project to be successful. The metrics may be used to answer the question of “What management mechanisms will help the organization optimize its investment in the new project.” For this quadrant, the change management system 100 may capture metrics associated with change management objectives, goals and priorities associated with the business case and journey management for the process of implementing the change. The metrics may measure management mechanisms for managing behavior changes as the project moves through the phases to completion. The metrics may identify the program management framework for managing the direction and pace of change, and the metrics may be associated with business value and pace of change.

The change leadership quadrant is shown in FIG. 4B and the metrics for this quadrant may be associated with whether leadership agrees with implementation of the project and promotes implementation of the project. The metrics may be used to help answer the question of “How can we help the organization's leaders champion the change.” The metrics for this quadrant may be associated with a steering committee appointed to manage the change, the buy-in sentiment of the leadership that the new change will improve the organization, leadership understanding of the project, leadership profiles, and leadership training. Leadership may include managers or other individuals higher up in an organization hierarchy. The goals associated with the metrics may include establishing a shared leadership vision and communicating it to the organization, developing a sponsorship program, providing leadership with coaching/facilitation, and setting expectations during change.

The change enablement quadrant is shown in FIG. 4C and the metrics for this quadrant may be associated with tools and support needed to make the change successful. The metrics may be used to help answer the question of “How do we give users the tools and support needed to make the change successful.” For this quadrant, the change management system 100 may capture metrics associated with training, job aids, performance support, training trainers, role mapping, identifying organization impacts, resource balancing, filling roles, and clarifying roles. The goals associated with the metrics may include designing the organization and jobs, revising workflows, redesigning the physical environment, designing new or modifying jobs, and providing training and performance support.

The change ownership quadrant is shown in FIG. 4D and the metrics for this quadrant may be associated with how to help users feel part of a change rather than victims of the change. The change management system 100 may capture metrics associated with communication, and measuring sentiment regarding the change process. The goals associated with the metrics may include planning communications and involvement activities, educating impacting personnel on the change process, developing local action teams to facilitate implementation, and delivering focused benefits.

The change management data capture module 101 shown in FIG. 1 may capture the metrics for the four-quadrant model and store the metrics in the data repository 100. The model builder 111 may organize the metrics in a schema that identifies the metrics for each quadrant, which may be used by the prediction engine 102 to calculate a score for each quadrant representing a readiness associated with each quadrant. The prediction engine 102 may make predictions for each quadrant as well as predictions for the overall model associated with change readiness and the ability to achieve project goals.

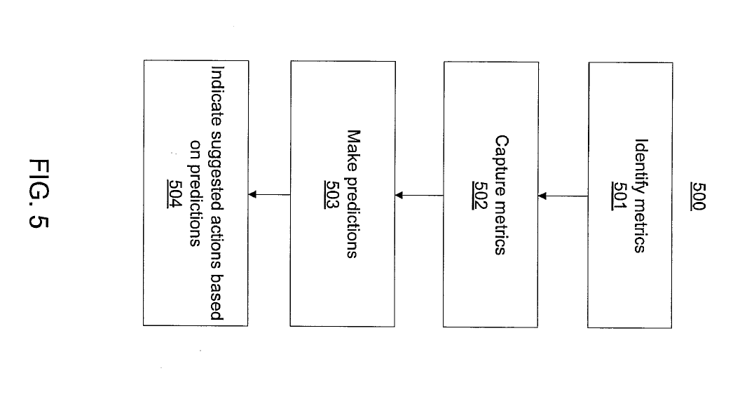

FIG. 5 shows a method 500 for change management, according to an embodiment. The method 500 and a method 600 described below are described with respect to the change management system 100 shown in FIG. 1 by way of example. The methods may be performed in other systems. Also, the methods are described with respect to implementing change associated with a new project for an organization to be implemented by way of example.

Regarding the method 500, at 501 metrics are identified for capturing information for change management. The metrics may include metrics for the project type and the project size. Examples of type may include transactional, transformational, and transitional. Other types may include department type or industry type (e.g., accounting, sales, information technology, manufacturing, etc.). Size may be associated with number of days to complete, estimated total cost or value realization, amount of behavior impacted, etc. Metrics may include project phase, such as blueprint, design, build, test, release and training, and estimated dates of completion for each phase. Metrics may include geographic scope, such as global, North America region, etc. Metrics may identify leadership and business case metrics, such as value and return on investment. Metrics may include the metrics described above with respect to the four-quadrant model. Different metrics may be stored in the change management system 100 and the change management data capture module 101 may generate a user interface via the dashboard 106 where a user can select metrics, enter new metrics or modify metrics. A dashboard may include a graphical user interface that provides reporting and allows for data entry.

At 502, the metrics are captured. This includes determining values for the metrics and storing the values. For example, the change management data capture module 101 captures the metrics from the data sources 150a-n and stores the metrics in the data repository 101.

At 503, change management predictions are made. For example, the prediction engine 102 determines predictions 310 based on the models 200 and metrics which may be in the current state 301, as shown in FIG. 3. Predictions may estimate readiness to move to a next phase of a project. The next phase may be the first phase if none of the phases have been implemented or a final phase where the project goes live or any intermediate phases. To go live may include implementing a new system or process in a production environment. Predictions may be made for specific geographies or regions. Readiness predictions may be made for each quadrant of the four-quadrant model, and an overall readiness prediction may be made for the entire model based on the predictions for each quadrant. Indications of a level of readiness may include scores, which can comprise numeric values within a range, color-coded indications, etc.

At 504, suggested actions are indicated based on the predictions to improve probabilities of achieving project goals and improving business value. For example, if predictions indicate a deficiency in the navigation quadrant, then training procedures may be verified and implemented. If predictions indicate a deficiency in the leadership or ownership quadrants, then a leadership meeting may be scheduled to provide a better understanding of the project and how the project will improve their efficiency.

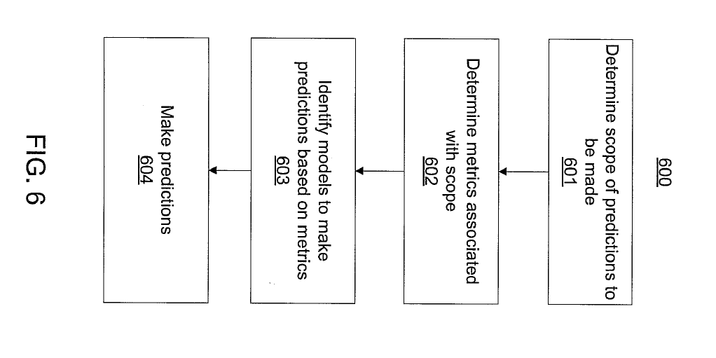

FIG. 6 illustrates a method 600 for determining readiness. One or more of the steps of the method 600 may be implemented as substeps of the step 503 in the method 500 or substeps of other steps of the method 500.

At 601, the prediction engine 102 determines the scope of the prediction to be made. The scope may be based on whether the prediction is for a project phase or completion of the project. The scope may identify the geographic region for the prediction, such as whether the prediction is for a particular site or a region. The scope may identify whether the prediction is for a particular quadrant of the four-quadrant model or for an overall readiness.

At 602, the prediction engine 102 determines the metrics associated with the scope. This may include metrics for a particular quadrant, geographic region, project phase, industry-type, etc. The metrics may include input metrics and output metrics. The input metrics describe the current state of the change, which may be the current state of a project. The output metrics are the predicted variables, such as a level of readiness for enablement, ownership, navigation, leadership, or predictions on metrics representing business value.

At 603, the prediction engine 102 identifies one or more models from the models 200 shown in FIG. 2 that are operable to make predictions of readiness for the metrics determined at 602. Different models may be selected for different scopes. For example, a model may be selected that is specific for the current phase, geographic region or quadrant. If the scope changes, different models may be selected.

In one example, the models may represent relationships between input and output metrics derived from analysis of historic change management data. In another example, the models comprise formulas for calculating a readiness prediction based on scope and input metrics. For example, enablement input metrics associated with readiness for the enablement quadrant may include number of people trained, result of training, identified and filled new roles, etc. A formula is used to determine a predicted level of readiness for enablement. The predicted level of readiness may be determined for each quadrant and for the entire model. Color-coded indications of readiness, such as red, yellow, or green, may be determined based on captured metrics.

An example of determining a color coding for a predicted level of readiness for the enablement quadrant is now described. The prediction for enablement may be based on input metrics comprising Training Materials, Training Logistics, Training Attendance, Training Environment, Job Aids, Performance Support, Train-the-Trainer, Role Mapping, Organizational Impacts Identified, Resource Balancing, Roles Filled, and Role Clarity. Values for these input metrics are determined and a color coding is determined for each of the input metrics. For example, for Training Materials: the color code is grey if no data is entered; green if =>80% of all training courses are completed; yellow if between 60% and 80% are completed; and red if =<60% are completed. For Training Logistics: grey if no data is entered; green if =>90% of all training logistics are green; yellow if between 30% and 90% are completed; and red if =<30% are completed. For Roles Filled, black if role mapping is not in scope; grey if current phase is plan, analyze, design, build or test; green if new staffing is checked; and red if unchecked.

Color coding is determined for other input metrics for enablement. Then, the color coding for the enablement quadrant is calculated based on the color coding of the input metrics. Color coding may similarly be determined for each quadrant of the four-quadrant model. Then, an overall readiness prediction is determined based on the quadrant color coding. For example, the overall readiness prediction may be green if all four quadrants are green; red if any two quadrants are red or 1 quadrant is red and the remaining three are yellow; and yellow for all other combinations.

At 604, predictions are made according to the selected models and metrics. Examples of determining predictions based on the model are described above.

Functions performed by the change management system 100 are now further described. Also, different types of the change management data 120 are now described. The change management data 120 may include data for tracking the changes throughout the life cycle of the project. Screen shots generated by the change management system 100 for capturing and reporting the change management data 120 are also shown. The screens may be generated via the user interface 105 by one or more of the components of the change management system 100.

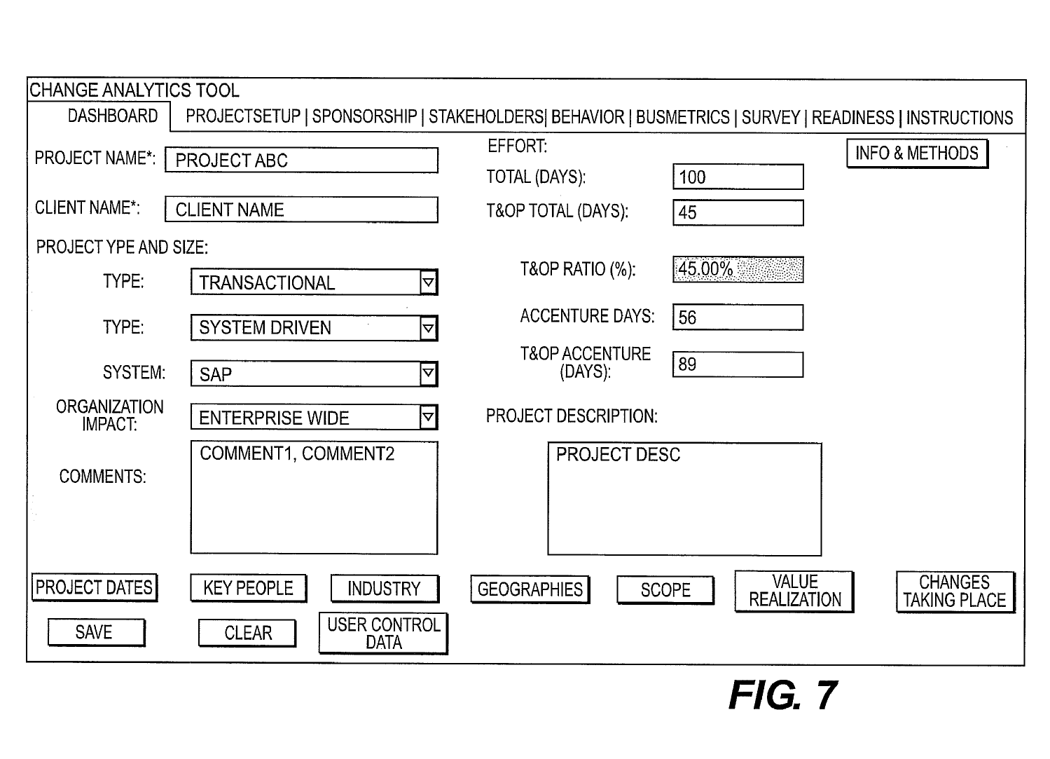

FIG. 7 shows a screen shot associated with project data. This includes the specific details on the project. Depending on the size and nature of the project, different tracking elements are turned on or off. Thus, different metrics are captured depending on the selections made in this screen describing the project details. The underlying business case value is also captured. The project data may include the project name, the type and size of the project, phases of the project and current phase (e.g., blueprint, design, build, test, release, training, etc.), timeline of the project, geography, key leaders, and business values. The business values may be used to determine how much project value was achieved based on performing or achieving different tasks. The business values are associated with why the project is being implemented.

Some of the project data may be populated through selections from drop-down menus. For example, one project type may be selected from transformation, transactional or transitional. Another project type may be selected from system driven, process driven or people driven. The type of system may also be selected from a drop-down menu of current systems. The organizational impact may be selected from enterprise wide, one division/function/business unit only, or multiple divisions/functions/business units.

Effort may be determined in terms of days. The effort may describe an estimated number of days to complete the project (shown as total days), an estimated number of days for talent and organization performance (T&OP), and a T&OP ratio comprised of T&OP total days/total days. The project data may include project dates to establish a timeline. The user may indicate whether various phases of the project are in-scope. The project data may include estimated business value for the project and a breakdown of how the business value is allocated across different areas. Project data associated with key people, geography, industry and project scope may also be captured. Some project data may be user-defined. Although not shown, a screen may be provided for entering information regarding “Other Changes Within the Organization”. The other changes may include descriptions of the behavior changes.

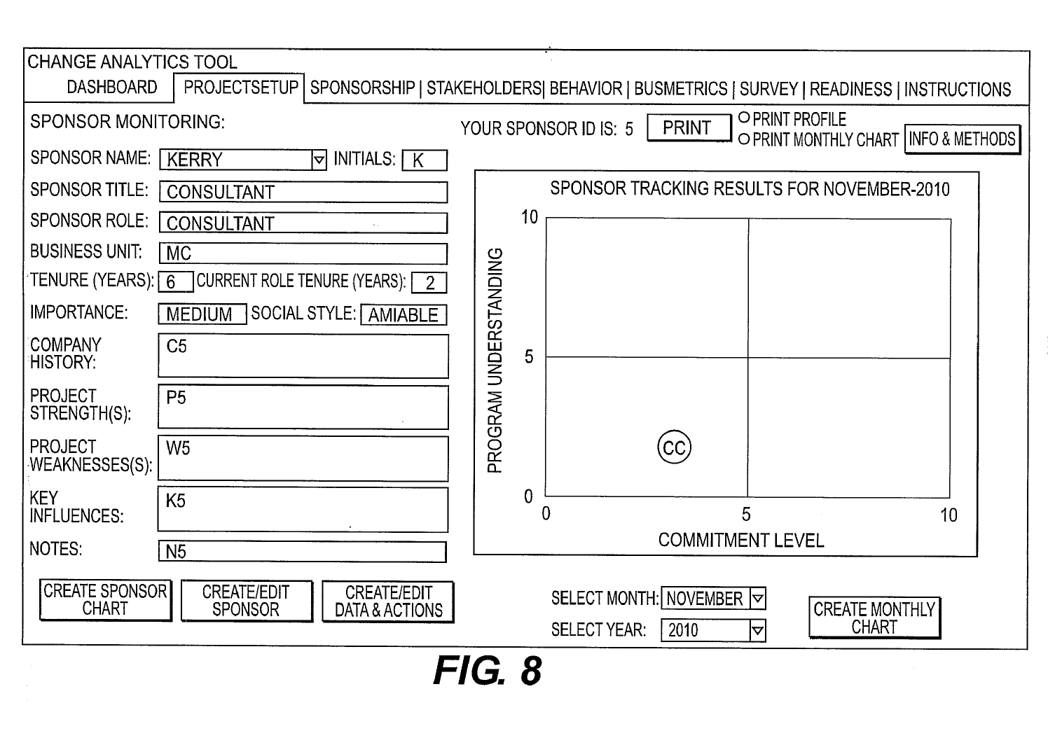

FIG. 8 shows an example of sponsorship monitoring results. A sponsor is a client or any person that is impacted by a change. A sponsorship monitoring process is performed throughout the phases of the project. The process may include capturing metrics associated with the commitment and understanding of sponsors. Scores for commitment and understanding may be calculated for each sponsor. For example, an organization may implement a project to use a new business process tool in order to consolidate processes on one system, better manage data and provide easier and faster reporting. However, if the chief information officer does not know the underlying reason why the new tool is being implemented, and the project is perceived as added work with no benefit, then there are low commitment and understanding scores. In addition to numerical scores, color coding may be used to represent scores. As shown, red, yellow and green may be used to represent different levels of scores.

The change management system 100 also generates suggested actions based on the scores for commitment and understanding. The actions may be used to improve scores. A check box may be checked if an action is completed. Thus, the change management system 100 correlates certain actions with success in achieving project goals. The correlations may be determined by analyzing historic project data.

As part of the reporting data 130, the change management system 100 generates sponsorship monitoring results. The change management system 100 correlates key sponsors, commitment, and understanding to success of achieving projecting goals. An example of sponsorship monitoring results is shown in FIG. 8. Amount of success is improved by having sponsors in the top right quadrant. Also, the prediction engine 102 may generate values associated with success based on the number of sponsors in each box. Sponsor name may be selected from a drop-down menu of previously-entered sponsors in the project data. The user has options to create charts on the selected user, create/edit a sponsor, create/edit data and actions, and create a chart for any month. A sponsor profile may be entered describing characteristics of the sponsor. Data and actions for a sponsor may also be entered and an understanding score may be calculated based on a current entered score versus a previous month score.

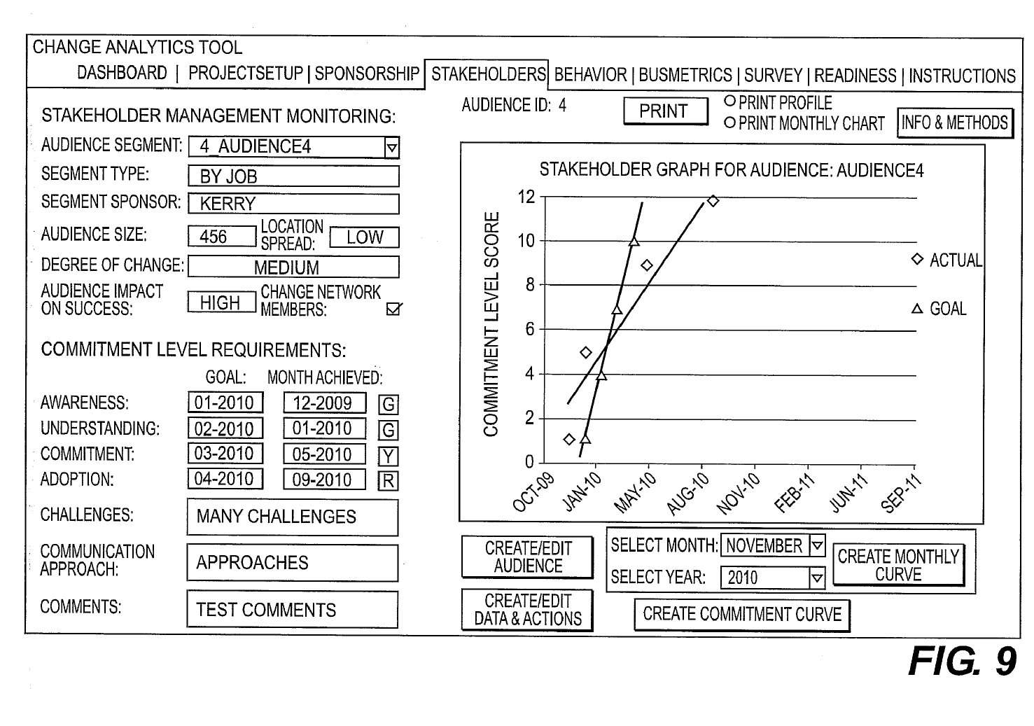

FIG. 9 shows a screen shot associated with stakeholders. Stakeholders are groups of people impacted by changes, for example, as a result of implementing a new project. For each group, metrics are captured and calculated to track the groups up a commitment curve related to support for changes. Stakeholder monitoring results associated with the curve may be displayed.

FIG. 9 also shows the stakeholders may be tracked by segment. For example, FIG. 9 shows a segment type “By Job”. The metrics for the segment may be associated with awareness, understanding, commitment, and adoption. A goal and date achieved may be provided for each metric and a color coding, such as red, yellow, or green may be shown based on achieving the goal. Tabs are also provided for creating/editing an audience segment, data and actions, and commitment curves for a selected month or year.

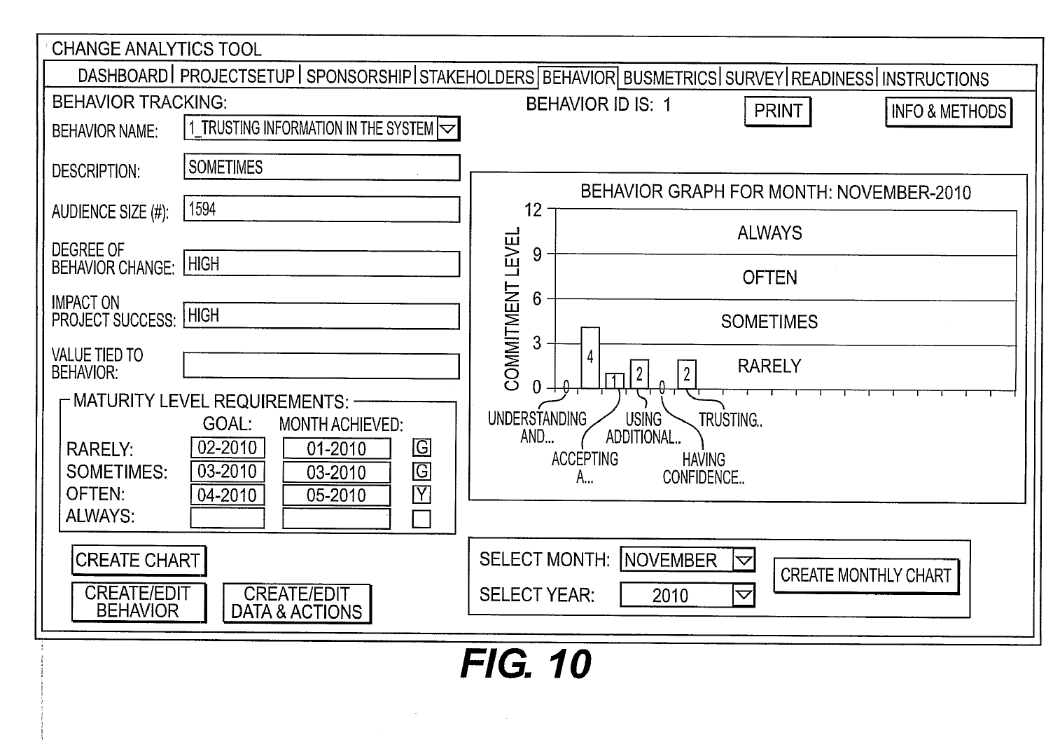

FIG. 10 shows a screen shot associated with behaviors that drive business results. These behaviors may be behavior changes that need to be made to implement a project. The behavior changes are behaviors that someone would have to do differently for the project to be successful. Dollar amounts (or other monetary amounts) may be associated with each behavior change representing impact on business value. The dollar amounts may be determined based on historical analysis of data for similar projects. Based on the dollar amount predictions, behavior changes may be prioritized.

Behavior changes may be determined at the blueprint phase of a project. The behavior changes are listed and metrics are identified for tracking the behavior changes. The prediction engine 102 makes predictions, for example, for dollar amounts or percentage of successfully achieving project goals are determined for each behavior change.

Behavior changes may be categorized using a maturity scale; e.g., rarely, sometimes, often and always. The maturity scale may indicate a degree of occurrence for each behavior change. For example, a new behavior may be exhibited on a periodic basis (e.g., often). Whereas, an organization that has adjusted to the new behavior may exhibit the adapted behavior on a consistent basis (e.g., always). Maturity may tie into value. For example, a behavior change that is always exhibited may be tied to greater business value. If the behavior change is rarely exhibited the project will have a low likelihood of success.

The behavior changes are tracked throughout the lifecycle of the project to determine if they are being performed. If not, corrective actions may be taken. Also, predictions are checked for accuracy as the project proceeds over time.

FIG. 10 shows information entered for a behavior, such as behavior name, description (e.g., in terms of maturity), audience size, degree of behavior change, impact on project success, and value tied to behavior. Under maturity level requirements, for each maturity level, a goal and month achieved are shown. Also, a score may be calculated for each maturity level. For example, the score may be represented as green, yellow, red or grey. The scores may be calculated based on formulas. For example, a score is green if the goal is achieved in a current month or earlier, or the goal month has not yet been reached and the previous level has been achieved. The score may be yellow if the goal is achieved after the goal month, or it is the current month for goal accomplishment and the level has not been achieved. The score may be red if the goal has not been achieved after the goal month. The score may be grey if the previous commitment level has not been achieved. Also, FIG. 10 shows that charts may be created and behaviors and data and actions for behaviors may be created and edited. One chart that is shown in FIG. 10 is the behavior graph for a month (e.g., November 2010). The behavior graph includes a commitment level on the y-axis and metrics on the x-axis. The behavior graph shows a commitment level score for each metric. Although not shown, another chart that may be shown includes a behavior scale illustrating the commitment level for the behavior and how the commitment level has progressed from the start and how far the current commitment level is from the goal.

Although not shown, addition screens may be provided for creating or editing a behavior. Some of the information may be entered via drop-down menus. For example, the behavior type may be selected from analytical, driver, amiable, or expressive. One or more stakeholder groups may be added to the behavior. The number of stakeholder groups added is shown along with the audience size, which is the total number of audience members for all the stakeholder groups.

The degree of behavior change may be selected from high, medium or low. The maturity level may be selected from never, rarely, sometimes, often and always. Also, maturity level requirements may be entered in terms of month and year to achieve the behavior.

Actions for a behavior may be entered. The maturity level may be selected from a pull-down menu. Also, the range may be selected from high, medium or low. The trend may be calculated based on the score of the previous month.

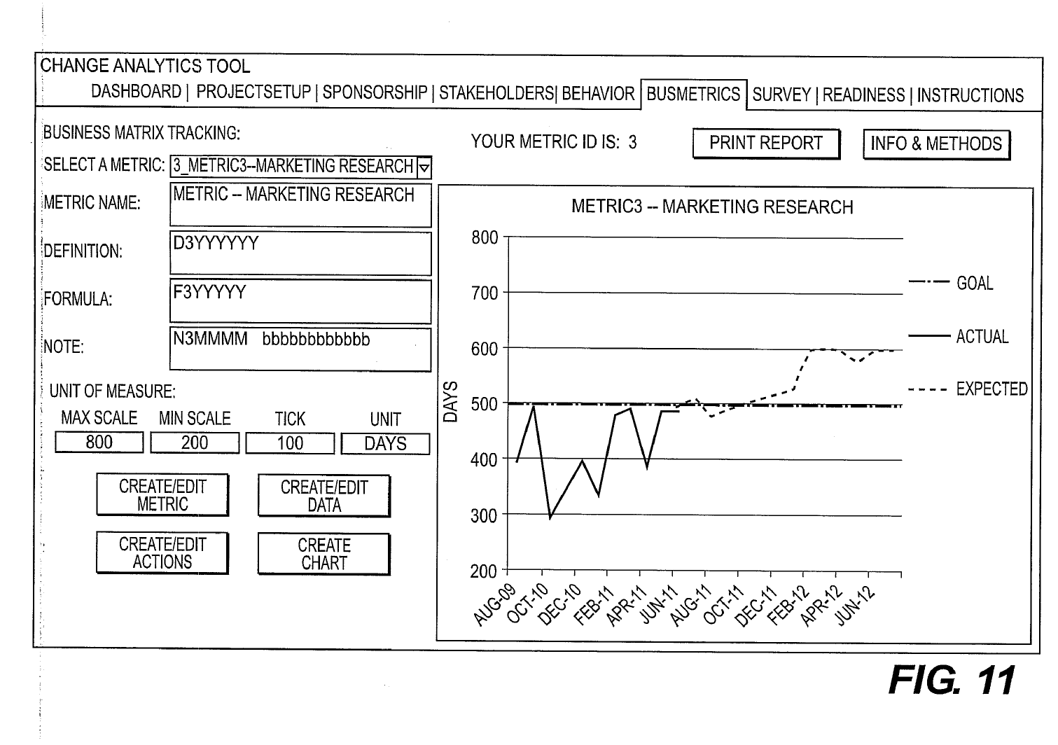

FIG. 11 shows a screen shot associated with metrics captured by the change management system 100. The metrics may include metrics already used by the organization implementing the project to track progress and performance. For example, one or more of the metrics may include existing metrics used to evaluate the performance of a process. The change management system 100 may plot and track measured metrics versus project goals. Also, actions are tracked and the metrics are correlated to success of reaching goals. The prediction engine 102 may make predictions on amount of improvement or reduction in metrics over the timeline of the project.

FIG. 11 shows that a metric name, definition, formula, and note may be entered for a metric. Also, a unit of measure may be entered for the metric. Also, screens may be provided for creating and editing metrics, associated actions, data and charts.

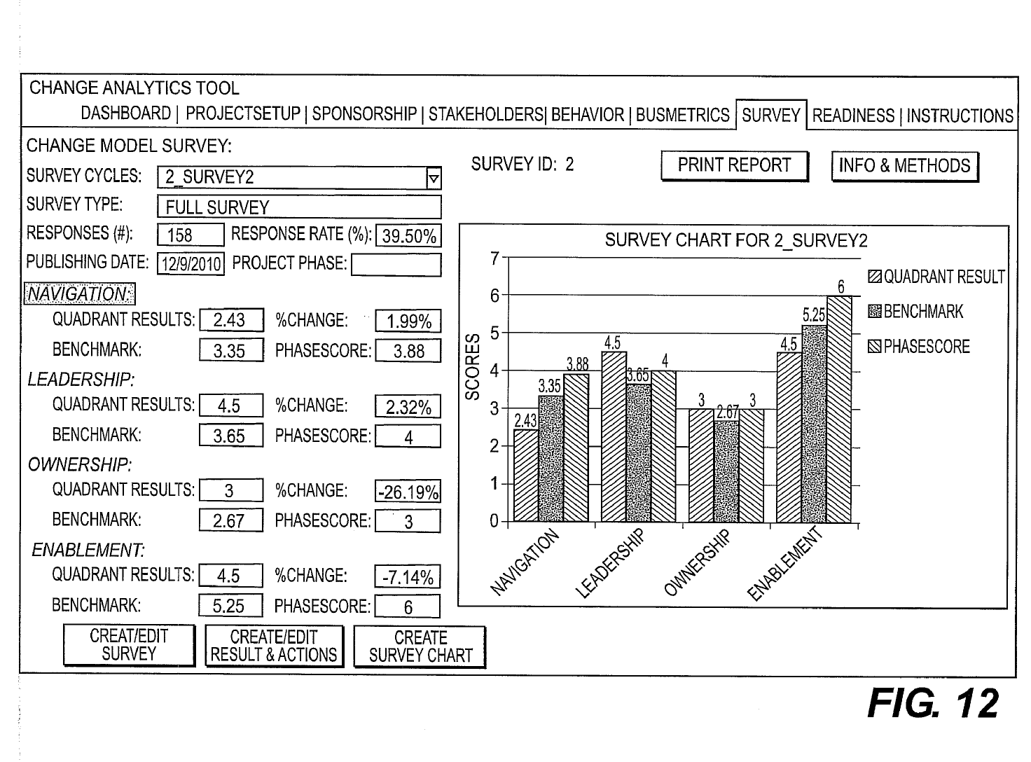

FIG. 12 shows screen shots associated with surveys. Surveys may be used to capture the change management data 110. The surveys may be provided online and users may enter the data via a computer system, which functions as one of the data sources 150a-n shown in FIG. 1. The survey questions may be based on the quadrants and associated metrics from the quadrant model.

The survey questions may be specific to the change process and the current challenges facing projects. Questions may include questions related to the clients culture. Also, questions for each phase may be developed from scratch. Surveys may be used to capture data at pre-live and post-live phases. Quadrant model survey results may be generated that include scores, insights and actions for each quadrant.

FIG. 12 shows data for the survey. Some of the data may include data entered through other screens. Survey results are shown for each quadrant. Scores may be calculated from the survey results. For example, scores are calculated based on the overall results for each series of questions that correspond with a quadrant of the model. The change managements system 100 allows questions to be added, removed or modified, and questions may be associated with a quadrant of the four-quadrant model.

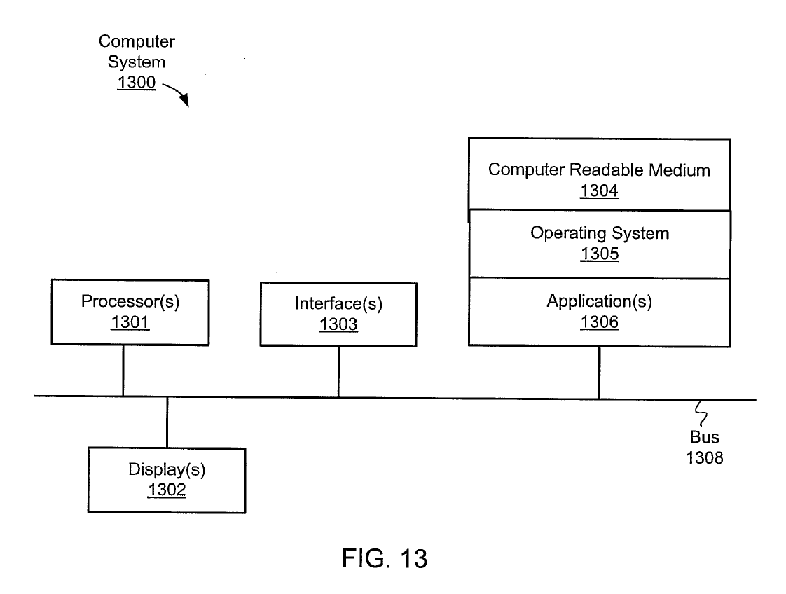

Referring to FIG. 13, there is shown a computer system 1300 for the change management system 100. It is understood that the illustration of the computer system 1300 is a generalized illustration and that the computer system 1300 may include additional components and that some of the components described may be removed and/or modified.

The computer system 1300 includes processor(s) 1301, such as a central processing unit, ASIC or other type of processing circuit; display(s) 1302, such as a monitor; interface(s) 1303, such as a network interface to a Local Area Network (LAN), a wireless 802.11x LAN, a 3G or 4G mobile WAN or a WiMax WAN; and a computer-readable medium 1304. Each of these components may be operatively coupled to a bus 1308. A computer readable medium (CRM), such as CRM 1304 may be any suitable medium which participates in providing instructions to the processor(s) 1301 for execution. For example, the CRM 1304 may be non-transitory or non-volatile media, such as a magnetic disk or solid-state non-volatile memory or volatile media such as RAM. The instructions stored on the CRM 1304 may include machine readable instructions executed by the processor 1301 to perform the methods and functions of the change management system 100.

The CRM 1304 may also store an operating system 1305, such as MAC OS, MS WINDOWS, UNIX, or LINUX; and applications 1306. The applications 1306 may include word processors, browsers, email, instant messaging, media players, etc. The applications 306 may include the modules and engines of the change management system 100, which are executed by the processor 1301. The operating system 1305 may be multi-user, multiprocessing, multitasking, multithreading, real-time and the like. The operating system 1305 may also perform basic tasks such as recognizing input from the interface 1303, including from input devices, such as a keyboard or a keypad; sending output to the display 1302 and keeping track of files and directories on CRM 1304; controlling peripheral devices, such as disk drives, printers, image capture device; and managing traffic on the bus 1308.

Also, the change management system 100 may be implemented in a distributed computing system, such as a cloud system. The computer system 1300 may be part of a distributed computer system hosts and executes the change management system 100.

While the embodiments have been described with reference to examples, those skilled in the art will be able to make various modifications to the described embodiments without departing from the scope of the claimed embodiments.

What is claimed is:

1. A change management system comprising:
a change management data capture module to capture metrics associated with phases of a project and associated with a change management model;
a prediction engine, execute by a processor, to generate predictions indicating a level of readiness to move to a next phase of the project based on the model and to indicate actions for achieving goals of the project based on the predictions; and
a reporting module to provide via a user interface an indication of the predictions, the actions and a current change management state of the project.

2. The change management system of claim 1, comprising:
a simulation module to provide variations of the current change management state of the project to the prediction engine to simulate changes to the current management state, and to generate predictions indicating whether the variations improve readiness to move to a next phase of the project.

3. The change management system of claim 1, wherein the model comprises a four-quadrant model including quadrants for change navigation, change leadership, change enablement, and change ownership, and the prediction engine generates scores for each quadrant based on the predictions,
wherein the predicted level of readiness is determined from the scores.

4. The change management system of claim 3, wherein the change navigation quadrant includes metrics measuring management mechanisms for managing behavior changes as the project moves through the phases to completion, the change leadership quadrant includes metrics measuring sentiment or understanding of leadership with regard to benefits of implementing the project, the change enablement quadrant includes metrics measuring support for initiating changes resulting from the project implementation, and the change ownership quadrant includes metrics measuring sentiment regarding a change process.

5. The change management system of claim 3, wherein the scores are associated with sponsorship, stakeholders, and change behaviors.

6. The change management system of claim 1, wherein the change management data capture module administers surveys to capture the metrics.

7. The change management system of claim 1, wherein the change management data capture module captures project setup information and the change management system determines the metrics based on the project setup information.

8. The change management system of claim 1, wherein the prediction engine predicts commitment and understanding for sponsors based on the captured metrics.

9. The change management system of claim 1, wherein the change management system determines stakeholder results on a commitment curve related to support for changes.

10. The change management system of claim 1, wherein the prediction engine determines a maturity of a behavior change and determines value of the behavior change based on the maturity of the behavior change.

11. The change management system of claim 1, wherein the prediction engine determines a scope of the prediction to be made based on at least one of project phase, geographic location, model type, and industry type, determines the metrics based on the scope, selects a prediction model from a plurality of prediction models based on the metrics, and determines the prediction from the selected model.

12. A method of managing change for a project implementation, the method comprising:
storing metrics associated with phases of the project and associated with a change management model;
generating, by a computer processor, a prediction indicating a level of readiness to move to a next phase of the project based on the model;
indicating actions for achieving goals of the project based on the prediction; and
generating via a user interface indications of the prediction, the actions and a current change management state of the project.

13. The method of claim 12, comprising:
receiving variations of the current change management state of the project;
simulating the current management state with the variations; and
generating a prediction indicating whether the variations improve readiness to move to a next phase of the project.

14. The method of claim 12, wherein the model comprises a four-quadrant model including quadrants for change navigation, change leadership, change enablement, and change ownership, and generating a prediction comprises generates scores for each quadrant based on the predictions, wherein the predicted level of readiness is determined from the scores.

15. The method of claim 14, wherein the change navigation quadrant includes metrics measuring management mechanisms for managing behavior changes as the project moves through the phases to completion, the change leadership quadrant includes metrics measuring sentiment or understanding of leadership with regard to benefits of implementing the project, the change enablement quadrant includes metrics measuring support for initiating changes resulting from the project implementation, and the change ownership quadrant includes metrics measuring sentiment regarding a change process.

16. The method of claim 12, comprising predicting a degree of commitment and understanding for sponsors based on the metrics.

17. The method of claim 12, comprising determining stakeholder results on a commitment curve related to support for changes.

18. The method of claim 12, comprising:
determining a maturity of a behavior change; and
determining value of the behavior change based on the maturity of the behavior change.

19. The method of claim 12, wherein generating a prediction comprises:
determining a scope of the prediction to be made based on at least one of project phase, geographic location, model type, and industry type;
determining the metrics based on the scope;
selecting a prediction model from a plurality of prediction models based on the metrics; and
determining the prediction from the selected model.

20. A non-transitory computer readable medium comprising machine readable instructions that when executed by a processor perform instructions to:
store metrics associated with phases of a project and associated with a change management model;
generate a prediction indicating a level of readiness to move to a next phase of the project based on the model;
indicate actions for achieving goals of the project based on the prediction; and
generate via a user interface indications of the prediction, the actions and a current change management state of the project.
